(19) United States
(12) Patent Application Publication
(10) Pub. No.: US 2005/0082818 A1
(43) Pub. Date: Apr. 21, 2005

(54) Method for producing a sheet of postage stamps, and sheet of postage stamps

(76) Inventor: Gereon Mertens, Feldafing (DE)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/939,993

(22) Filed: Sep. 14, 2004

(30) Foreign Application Priority Data
Sep. 17, 2003 (DE) 103 42 947.6

(51) Int. Cl. G09F 3/00

(52) U.S. Cl. 283/71

(57) ABSTRACT

A method for producing a sheet of postage stamps (10) and a corresponding sheet of postage stamps are described, a plurality of postage stamp motifs (20) being printed on the regions (24) provided for the individual postage stamps and a plurality of further items of information (40) being printed on regions (26) not provided for the postage stamps. The regions provided for an individual postage stamp and the information regions with the further items of information are then separated from each other by perforations (30) and/or a separation process. The separation process and/or the perforation takes place in such a way that a relationship is produced between at least one respective information region (42) comprising further items of information and a predetermined number of postage stamps.

### PRIOR ART

The invention takes as its starting point a method for producing a sheet of postage stamps and a corresponding sheet of postage stamps according to the preamble of the independent claims.

Postage stamps, i.e. self-adhesive stamps or stamps with an adhesive coating, which adhere after moistening, are generally produced using the roll method or on sheets. With the roll method the paper or plastics material for the postage stamp is unwound from a roll and the production method is carried out using the unwound roll web. The paper or plastics material generally already coated with the adhesive layer is initially printed with a plurality of motifs, which are to decorate the subsequent stamps, and are then provided with perforations that separate the stamps from each other and from an edge region. The individual manageable sheets of stamps provided for the customers are then separated from the roll web or from the larger sheet provided for manufacture.

The known postage stamp sheets usually have a plurality of decorative motifs which are separated from each other by perforations, so the individual postage stamps of the sheet may be easily detached from each other. The perforations also separate the postage stamp motifs from a usually white edge which remains as waste as the stamps are used. The individual postage stamps on the postage stamp sheet also have an item of information containing the value of the postage stamp. This information is arranged in the region provided for the postage stamp. A postage stamp sheet of this type can contain, for example 10, 20 or more stamps side by side, separated by perforations.

A stamp composed of two parts is known from document DE 695 01 948 T2. The assembled stamp has a determining part which determines the value of the stamp. A smaller, image-bearing part can be glued onto a region of the determining part, so a plurality of designs, presented by the image-bearing part, can be used for one stamp with a specific nominal value. Both parts of the assembled stamps are arranged on a sheet of stamps.

Further embodiments of known stamps can be inferred from abstracts of Japanese patent applications. The abstract JP 08022249 A describes a stamp comprising an advertising component. The abstract JP 2001109380 A describes a stamp which has an empty area which can be printed with images or text or numbers.

When selling, in particular relatively large quantities of stamps, it is sometimes necessary for the post office official to provide a receipt or to record and possibly confirm specific details on the stamps sold for a philatelist.

### ADVANTAGES OF THE INVENTION

The method according to the invention for producing a sheet of postage stamps comprising the features of independent claim I has the advantage, compared with the known method, that a sheet of postage stamps can be produced very easily and inexpensively which allows the post office official to provide the corresponding information or receipts for the postage stamp customer very easily and quickly. The sheet of postage stamps according to the invention with the features of independent claim 9 accordingly has the advantage that a post office official can issue the receipts or information demanded by the postage stamp customer easily and inexpensively. Waste is also avoided as a result of the sheet of postage stamps according to the invention and previously unused parts of the sheet of postage stamps have a meaningful use.

Advantageous developments and improvements to the articles indicated in the independent claims are possible owing to the measures listed in the dependent claims.

It is particularly advantageous that the further items of information provided on the sheet of postage stamps contain form-like details. Form-like details are taken to mean, for example, a pre-printed head of the issuing authority, pre-printed lines for specific details, a field for a signature or stamp or generally, the lines denoting details such as the date, name, item, price or currency or the like. These details are arranged in such a way that by adding missing data, a post office official can very quickly issue the receipts provided, for example, for submitting to the tax office or corresponding to other regulations. The details to be added by the post office official are provided here by lines and optionally by the details denoting the entry, so the person filling in the details recognises without difficulty and as it were intuitively what needs to be entered in the corresponding fields. It is therefore advantageous, for example, to configure this form as a type of receipt. In another embodiment the form can also contain a reference to the origin of the postage stamps, for example the year of production of the postage stamps, the issue date and other information of interest to philatelists.

The method for producing a sheet of postage stamps according to the invention is advantageously inexpensive if the further items of information are printed jointly with the postage stamp motifs.

The perforations are advantageously introduced by means of needle perforation, grinding perforation or laser perforation. Needle perforation is the method in which the perforations are produced by means of needles piercing the paper or plastics material from above or below. With grinding perforation projections are produced in the paper or indentations in the plastics material on one side of the sheet or roll web, for example the back, in the regions to be provided with perforations by pins, and these projections or indentations are subsequently ground. A laser perforation uses a laser of correspondingly pre-adjusted laser intensity to introduce the perforations, so the paper or plastics material to be provided with perforations is perforated as it were at the appropriate points. With needle perforation a large number of needles are provided over a specific, predetermined area and are arranged at the points at which the perforation is to subsequently be made, to introduce perforations into a sheet or a roll web. The needles are arranged over an appropriately large area. In contrast, the pins for grinding perforation are generally arranged on the circumferential surface of a cylinder, wherein, on unwinding of the circumferential surface, the pins are arranged at the points where the perforations are subsequently to be produced. In one embodiment, the pins may be fixed on a grinding cylinder, in another embodiment the grinding cylinder may be magnetic and comprise magnetic, flexible plates which in turn carry pins, the magnetic plates resting on the magnetic surface of the cylinder. Flat masks which at the points at which the perforations are to be produced, have holes for the penetration of the laser beam are generally provided for laser perforations. These masks are arranged above or below the sheet or roll web region to be processed, the laser beam penetrating through the mask producing the perforations in the sheet or roll web material.

The cuts to be made in the method according to the invention are particularly advantageously produced by means of cutting or punching out.

To produce a large number of postage stamp sheets it is advantageous to carry out printing and perforating using the roll method or sheet method. In the sheet method large sheets, for example 1×1 m in size, are processed, while in the roll method, the paper or plastics material is unwound from a roll in webs and these webs then pass through the individual processing stations one after the other. Only after printing and perforation are the sheets of stamps or the roll web cut to a size intended for the customers.

### DRAWINGS

Embodiments of the invention are illustrated with reference to drawings and described in more detail in the following description. In the drawings:

FIG. 1 schematically shows a sheet of postage stamps according to the invention,

FIG. 2 schematically shows a detail of a sheet of postage stamps according to the invention, and

FIGS. 3 and 4 each schematically show a method according to the invention for producing a sheet of postage stamps.

### DESCRIPTION OF THE EMBODIMENTS

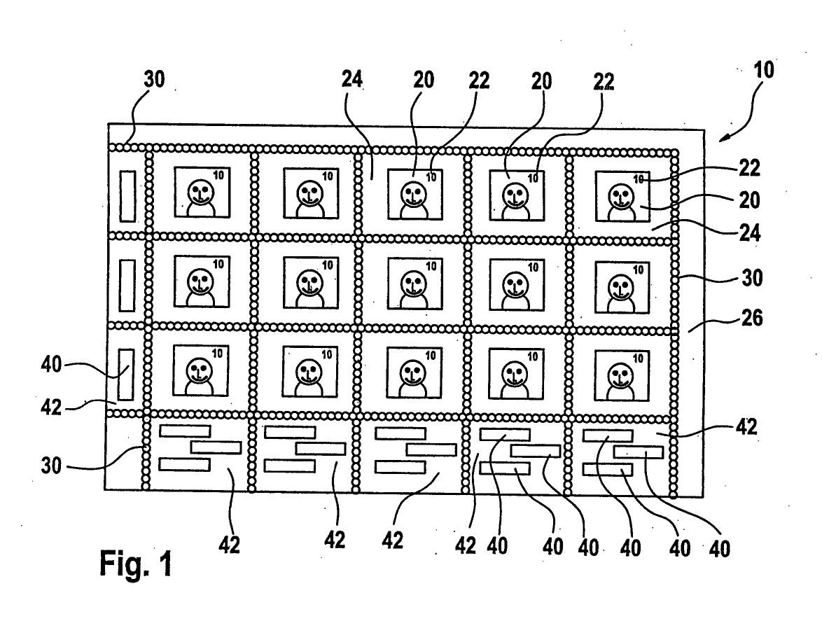

FIG. 1 shows a sheet of postage stamps 10 according to the invention comprising a plurality of motifs 20 in regions 24 intended for the postage stamps. The postage stamp region also contains the indication of a nominal value 22, in this case the nominal value 10, which indicates the value of the postage stamp. The nominal value usually also contains currency information, but this is not shown here. The individual postage stamps are separated from each other by perforations 30. In the embodiment described with reference to FIG. 1, the sheet of postage stamps comprises 5×3 stamps, but any other desired quantity of stamps may also be provided on a sheet of postage stamps. The stamps in the embodiment illustrated with reference to FIG. 1 are arranged in such a way that they are ordered in three rows, each with five stamps, located one above the other or, in other words, are ordered in five columns, each with three stamps, located side by side.

The regions 24, intended for the postage stamps, also have obvious or concealed security features which allow the authenticity of the stamps to be verified, for example by bar codes, fluorescent or phosphorescent pigments, mottling fibres, holograms or the like. Verification can take place using the human eye or a verification apparatus.

In one edge region 26, the sheet of postage stamps according to the invention comprises regions 42 which are not provided for stamps but contain further items of information 40. These will be called information regions 42 hereinafter. Either a row of stamps, each containing five stamps, or a column of stamps, each containing three stamps, is associated with each information region 42. The information regions 42 comprising further items of information 40 are unambiguously separated from each other by perforations 30 and a correspondingly arranged cut edge of the sheet of postage stamps 10 and associated with the above-indicated rows or columns of postage stamps.

In further embodiments of the invention an information region may also extend over two or more rows or columns or be provided on each side of the corresponding row or column. However it is important in this case that the regions 42 comprising additional items of information 40 can clearly be associated with a specific number of postage stamps by perforations or by the provided cut edges of the sheet of postage stamps in each case. A relationship between the regions 42 comprising the further items of information 40 and a specific number of postage stamps is produced hereby. When issuing the postage stamps the receipts may consequently also be easily separated from the remaining postage stamps or information regions by the post office official or other sales personnel.

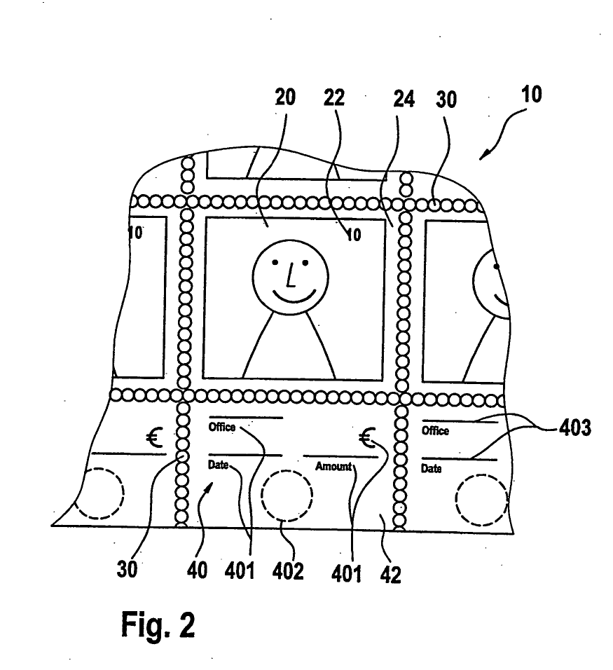

FIG. 2 shows a detail of a sheet of postage stamps 10 according to the invention. In this case, the reference numerals already used in FIG. 1 designate the same components of a sheet of postage stamps according to the invention as in FIG. 1. In the information region 42 of the enlarged, schematic illustration of a sheet of postage stamps according to the invention shown in FIG. 2 it can be seen that the further items of information 40 can have different characteristics. On the one hand, these further items of information can contain text information 401 such as office, date, amount and euro or numerical details. The further items of information may also be configured as lines 403 which allow the post office official or the sales personnel to add specific information quickly and easily. In addition, fields for applying a stamp 402 or a signature may be provided, so the details on the regions 42 containing the further items of information 40 can be properly authorised. Form-like details of this type can be used, on the one hand, to issue a sales receipt for a specific number of postage stamps and on the other hand important information may also be added or confirmed in this region 42 for the philatelist. It is therefore possible for the post office official or another postage stamp seller to enter and possibly confirm corresponding receipts or postage stamp information very simply and without great effort. It is particularly advantageous in this case that edge regions on sheets of postage stamps now have a use and no longer merely form waste. Additional forms no longer have to be provided either for confirmation of details or sales information.

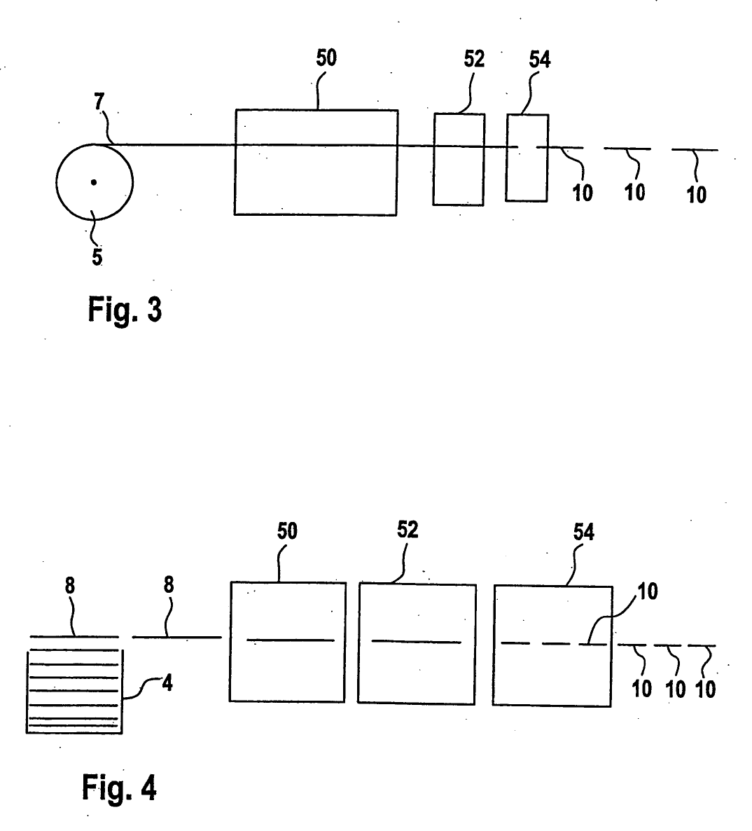

FIG. 3 and 4 schematically show methods according to the invention for producing sheets of postage stamps.

A roll method is described with reference to FIG. 3, in which the paper or plastics material, of which subsequent postage stamps consist, is unwound from a roll 5 and passes through a plurality of processing stations as a roll web 7. The roll web 7 is printed with the appropriate postage stamp motifs, the postage stamp nominal value and further information, for example form-like details, in a first station 50. Examples of printing methods here are letterpress, gravure, screen or flat-bed printing. Multi-coloured printings are generally used, so the printing station 50 is multi-stage in construction, i.e. usually comprises one stage per colour. In certain printing methods, for example offset printing, one drying unit per stage may be provided which connects to the corresponding print stage. A drying unit of this type could, for example, use UV radiation for drying purposes.

The printed roll web 7 is perforated by means of needle perforation, grinding perforation or laser perforation in a subsequent station 52. Here the perforations are provided in such a way that the regions provided for the individual postage stamps are separated from each other and the information regions containing further items of information can each be associated with a specific number of postage stamps.

The roll web 7 is divided in a connecting station 54 into small sheets by means of cutting and/or punching in such a way that, on the one hand, sheets with a predetermined number of postage stamps are produced and, on the other hand, the respective regions comprising further items of information, for example form-like details, are associated with a specific number of postage stamps on these sheets. The sheets of postage stamps described with reference to FIG. 1 and 2 are thus produced.

The method analogous to FIG. 3 is described with reference to FIG. 4, sheet processing being provided in this case. The sheets 8, on which the postage stamps are to be provided, are conveyed from a bin 4 to a conveyor belt (not shown) and conveyed thereby to a printing station 50. Here the sheets are provided with printings analogous to the embodiment described with reference to FIG. 3. The sheets 8 are provided with perforations in a subsequent station 52, likewise analogous to the embodiment described with reference to FIG. 3, and are cut and/or punched in an adjoining station 54 into the sheets of postage stamps 10 suitable for customers.

In preferred embodiments the paper or plastics material webs wound on rollers 5 are provided with a coating which adheres after the addition of moisture. The paper or plastics material sheets 8 can similarly be provided with a corresponding coating before printing. The adhesive coating can, however, also first be applied later, for example after printing

The method according to the invention for producing a sheet of postage stamps may also be used for sheets of postage stamps which contain self-adhesive postage stamps on a backing. In this case, the further items of information are separated from other further items of information and the predetermined number of stamps are separated from each other by punched-out regions which do not penetrate the backing.

1. Method for producing a sheet of postage stamps (10), a plurality of postage stamp motifs (20) being printed on the regions (24) provided for the individual postage stamps, and a plurality of further items of information (40) being printed on the regions (26) not intended for the postage stamps, and the regions provided for an individual postage stamp being separated from each other by perforations (30) and/or by at least one separation process, characterised in that the further items of information in information regions (42) and a first predetermined number of postage stamps are separated from each other by at least one separation process and/or perforations in such a way that a relationship between at least one respective information region comprising further items of information and a second predetermined number of postage stamps is produced.

2. Method according to claim 1, characterised in that the information region comprising further items of information contains form-like details (401, 402, 403).

3. Method according to claim 2, characterised in that the form-like details contain a receipt form or details on the issue data of the postage stamps.

4. Method according to claim 1, characterised in that the plurality of further items of information is printed jointly with the postage stamp motifs.

5. Method according to claim 1, characterised in that the perforations are introduced by means of needle perforation or grinding perforation or laser perforation.

6. Method according to claim 1, characterised in that the separation process takes place by means of cutting or punching out.

7. Method according to claim 1, characterised in that printing and perforation are carried out using the roll method.

8. Method according to claim 1, characterised in that imprinting and perforation are carried out using the sheet method.

9. Sheet of postage stamps (10), a plurality of postage stamp motifs (20) being printed on the regions (24) provided for the individual postage stamps, and a plurality of further items of information (40) being printed on the regions (26) not provided for the postage stamps, and the regions provided for an individual postage stamp being separated from each other by perforations (30) and/or at least one separation process, characterised in that the further items of information in the information regions (42) and/or a first predetermined number of postage stamps are separated from each other by at least one separation process and/or perforations in such a way that a relationship between the at least one respective information region comprising further items of information and a second predetermined number of postage stamps is produced.

10. Sheet of postage stamps according to claim 9, characterised in that the information region comprising further information contains form-like details (401, 402, 403).

11. Sheet of postage stamps according to claim 10, characterised in that the form-like details contain a receipt form or details on the issue data of the postage stamps.
